(19) United States
(12) Patent Application Publication
(10) Pub. No.: US 2010/0076926 A1
(43) Pub. Date: Mar. 25, 2010

(54) METHOD AND SYSTEM FOR DYNAMIC CONTACT INFORMATION MANAGEMENT IN ELECTRONIC COMMUNICATION DEVICES

(75) Inventors: Francesco Lecciso, Rome (IT); Sandro Piccinini, Rome (IT); Marco Secchi, Rome (IT); Antonio Secomandi, Brugherio (IT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/208,216

(22) Filed: Sep. 10, 2008

(51) Int. Cl. G06F 12/00

(52) U.S. Cl. 707/610; 707/E17.005; 711/E12.001

(57) ABSTRACT

A method and system for user contact information in electronic devices is provided. One implementation involves detecting a change in a user contact information at a first electronic device, determining effective date of the change in the contact information, storing the contact information change and effective date in a memory store, automatically communicating the contact information change and effective date to a second electronic device, and applying the received contact information change to a contact information list in a memory store of the second device, on or after the effective date.

### BACKGROUND OF THE INVENTION

1. Field of the Invention

The invention relates generally to information management, and in particular, to contact information management.

2. Background Information

With the proliferation of electronic communication devices, many users are increasingly utilizing such devices (e.g., cellular phones, smart phone, PDAs) for communicating. Such devices utilize certain information/attributes needed to identify contacts that are stored in what is known as a phone book, address book, or more generically, user contacts.

Such information/attributes are dynamic and in constant need of management due to e.g. changes in the list of contacts and their attributes. Moreover, it is really likely that a contact becomes obsolete over time because people are likely to change phone numbers or E-mail providers. For example, when a first individual changes his/her cell phone number, a second individual that has the first individual's original phone number in the second individual's contacts, has obsolete information.

### SUMMARY OF THE INVENTION

The invention provides a method and system for managing user contact information in electronic devices. One embodiment includes detecting a change in a user contact information at a first electronic device, determining effective date of the change in the contact information, storing the contact information change and effective date in a memory store, automatically communicating the contact information change and effective date to a second electronic device, and applying the received contact information change to a contact information list in a memory store of the second device, on or after the effective date.

Automatically communicating the contact information change and effective date to a second electronic communication device may further include, upon a request for communication with the second device, automatically communicating the contact information change and effective date to a second electronic communication device.

Automatically detecting a change in user contact information at a first electronic communication device may include detecting new contact information or a change in existing contact information, and determining effective date of the change in the contact information includes receiving the effective date of the change in the contact information from a user of the first device.

Applying the contact information change may further include, at the second device, comparing the effective date with a current date, such that if the effective date is on or after the current date, then applying the contact information change to a contact information list in the second device.

Automatically communicating the contact information change and effective date may further include automatically communicating the contact information change and effective date to multiple other electronic communication devices. Applying the contact information change may further include applying the contact information change contact information list in a memory store of each of a plurality of said other devices, on or after the effective date.

Automatically communicating the contact information change and effective date may further include automatically selectively communicating the contact information change and effective date to electronic communication devices of users with contact information in a contact information list at the first electronic communication device. Applying the contact information change may further include automatically applying the contact information change to the contact information list in the memory store of the second device, on or after the effective date.

Other aspects and advantages of the present invention will become apparent from the following detailed description, which, when taken in conjunction with the drawings, illustrate by way of example, the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a system for dynamic (automatic) contact list management in electronic communication devices, according to an embodiment of the invention.

FIG. 2 shows a flowchart of a process for (dynamic) contact list management in electronic communication devices, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for dynamic (automatic) contact list management in electronic communication devices. One embodiment involves a process for dynamically updating user contact list information based on a communication that transports certain updates (e.g., information, instructions) to a receiving communication device that is capable of automatically processing such updates, and can be configured for selective processing of such updates.

One implementation involves a process for managing contact information on an electronic device. The user of the device (first user) may change his/her contact information by activating a management module (e.g., a plug-in software module) which asks that user to provide his/her new contact information and an effective date when existing contact information is to be changed to the new contact information. The management module stores the new contact information and effective date in a storage module.

Each time the user of the device requests communication with another user (second user), the management module intercepts the request and checks if new contact information and effective date have been stored for the user. If new contact information and effective date have been stored for the first user, the management module then checks if the current date is on or after the effective date. If yes, the management module initiates communication with a receiving communication device for the second user utilizing said new contact information. Upon receiving the communication from the transmitting communication device, a management module of the receiving communication device updates the existing contact information of the first user, in the contact repository used by the receiving communication device, with the new contact information for the first user.

In one example, a management module in a communication device of a user A keeps track of updates to the user A phone number/attributes, as described above. Then, during a next electronic communication to a receiving communication device of a user B, the management module transmits information about said update so that a management module of the receiving communication device may identify that the incoming communication is from the user A and/or update contact list of the user B with updated contact information for the user A.

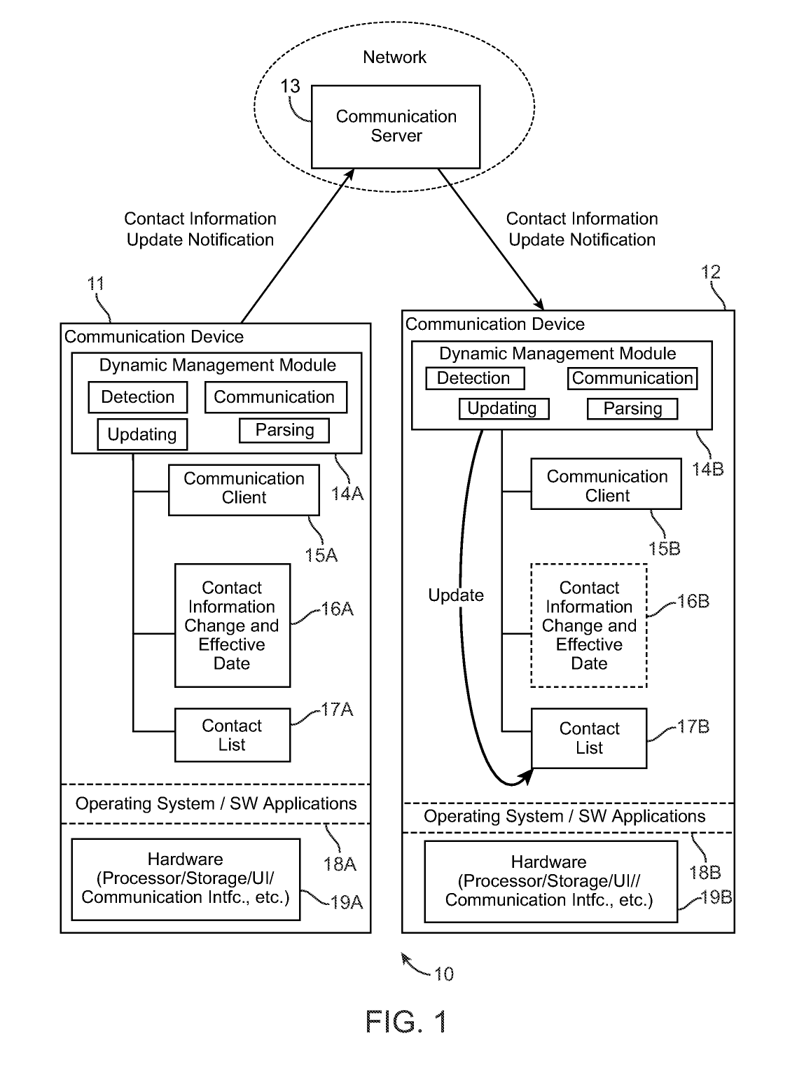

FIG. 1 shows a functional block diagram of a system 10 implementing dynamic (automatic) contact list management in electronic communication devices, according to an embodiment of the invention. The system 10 includes communication devices 11 and 12 which exchange information via a network, such a network including a communication server 13 (e.g., service provider) connected via the Internet. The communication devices may comprise consumer electronics devices for communications (e.g., cell phone, smart phone, PDA, notebook computer). The communication may be wired, wireless or a combination thereof. The communication device 11 includes a dynamic management module 14A (e.g., management client), a communication client module 15A (e.g., e-mail client, dialer client) which provides an interface to a user for communicating via the device, a storage module 16A for contact information change and effective date and a contact list module 17A including contact information for one or more individuals. The modules 14A, 15A and 17A may be implemented as software modules. The device 11 further includes operating system and software applications 18A, and hardware 19A for executing the software applications.

Similar to device 11, the communication device 12 includes a dynamic management module 14B (e.g., management client), a communication client module 15B (e.g., e-mail client, dialer client) which provides an interface to a user for communicating via the device, a storage module 16B for contact information change and effective date and a contact list module 17B including contact information for one or more individuals. The modules 14B, 15B and 17B may be implemented as software modules. The device 12 further includes operating system and software applications 18B, and hardware 19B for executing the software applications. In one implementation, the management modules 14A, 14B may be plug-in software modules that are downloaded to the communication devices 11 and 12, respectively, to operate in conjunction with existing software/hardware features of the devices.

In the example shown in FIG. 1, the management module 14A includes a detection module configured to detect contact information change and effective date, for a user A of device 11. The detection module stores the contact information change and effective date in a memory area of the device. When user A desires to communicate with user B of device 12 (i.e., upon a next communication from device 11 to device 12), a communication module of the management module 14A marks certain communication as a special communication (e.g., an electronic message marked to indicate contact information update notification) to indicate a contact information update. The special communication provides the changed contact information of user A to the device 12. The management module 14B in device 12 intercepts this special communication from device 11, and a parsing module of the module 14B parses the information therein for updated contact information indication. An updating module of the module 14B utilizes the updated contact information therein to update the contact information of user A in the contact list 17B for user B of the device 12. Such communication devices will offer the possibility to manually, and preferably, automatically process contact information update notifications.

In one example scenario, the transmitting device 11, having contact information that is about to be dismissed, offers the possibility to specify new contact information to be transmitted to the receiving device 12. The new contact information is intended to replace existing contact information or, alternatively, to be added as additional information (e.g., if a user adds a new number). User A can change his cell phone number and specify the time window when the new phone number is effective. Once the new contact information has been set, the new contact information is propagated automatically to all the contacts registered in the contact list of user A in device 11. For example, if user B information is in that contact list 17A of device 11, then the management module 14A automatically propagates new contact information of user A from device 11 to device 12, such that the management module 14B updates (or adds) new contact information of user A in the contact list 17B of user A.

In one implementation, the management module allows user A to select from the contact list 17A, those contacts to whom the new contact information of user A should be sent (although in FIG. 1 only two communication devices 11 and 12 are shown, the present invention is useful with more than two communication devices, wherein in one example the management module 14A sends contact information update notification to device 12 and other communication devices similar to device 12).

On the receiving device 12, the contact information update notification information from device 11 management module 14A may appear as a message that can be manually or automatically accepted depending on the settings of the receiving device management module 14B. If the sending device management module has indicated a time window, the receiving device management module properly maintains both the existing and the new contact information of user A until the time window has expired. Alternatively, the update can occur in a silent mode if the security configuration of the user B has this preference set. In another example, the contact information update notification message that is posted to user B to announce the change in contact information of user A, can be targeted to a service provider of user A, which can then offer the service of redirecting the update message to any caller that is attempting to contact the existing contact information number of user A.

The above scenario can also take place with user B device 12 (i.e., management module 14B) communicating changes in contact information of user B to device 11 of user A, wherein management module 14A updates such information in the contact list 17A of user A.

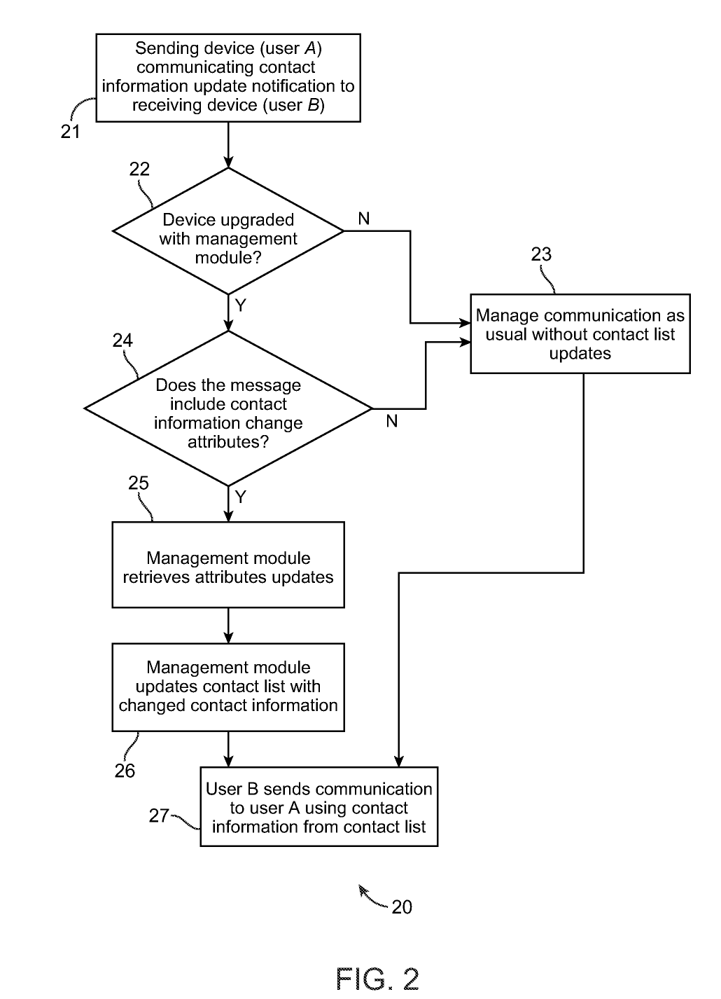

FIG. 2 shows a flowchart of a process 20 dynamic (automatic) contact list management in electronic communication devices, according to an embodiment of the invention. Process block 21 involves management module of a sending device 11 for user A sending a message including contact information update notification to a receiving device 12 for user B. The contact information update notification includes user A contact information change attributes (the contact information change attributes are typically new contact identifiers, date and hour when change will occur and any additional meaningful parameters). In process block 22, it is determined if receiving device 12 includes a management module for processing the contact information update notification. If not, the process proceeds to block 23, otherwise the process proceeds to block 24. In process block 23, the receiving device does not perform contact list update (processing the message as usual), and the process proceeds to block 27. In process block 24, it is determined if the incoming message includes contact information change attributes. If yes, the process proceeds to block 25, otherwise the process proceeds back to block 23. In process block 25 the management module retrieves contact information updates (attributes updates) from the message. In process block 26, management module updates the contact list of the receiving device with changed contact information. In process block 27, when the user B sends communication to user A, the contact information of user A is used such that user A receives the communication from user B.

In one example, user may define a communication message format (call, sms) as a vehicle for a contact information change communication. The sending device management module configures the communication message with additional attributes to manage address updates. The receiving device receives the communication message, and the management module of the receiving device then automatically retrieves said additional communication related to contact information change from the received message. The management module of the receiving device parses the change attributes in order to obtain the change details and the time when the changes updates are to be applied to the contact list in the receiving device. On or after the time for update, the management module of the receiving devices updates the contact information in the contact list, replacing the contact details with new ones and, at the same time, updating all device content (old sms, old incoming call list and so on). The user of the receiving device may change the setting of the management module of the receiving device to automatically apply updates to the contact list or to prompt the user before applying updates.

Each of the communication devices includes a user interface module (UI) such as display and input/output means, which the management module and client module use for user interaction (such as display of graphical user interface for displaying contact information, receiving changes to contact information, displaying notifications and allowing user to interact with the notifications, configuring the management module settings, etc.).

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements. Though the present invention has been described with reference to certain versions thereof; however, other versions are possible. Therefore, the spirit and scope of the appended claims should not be limited to the description of the preferred versions contained herein.

The terms “computer program medium,” “computer usable medium,” “computer readable medium”, and “computer program product”, are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium, such as a network link and/or a network interface, including a wired network or a wireless network, that allows a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method of managing user contact information in electronic devices, the method comprising:
detecting a change in a user contact information at a first electronic device;
determining effective date of the change in the contact information;
storing the contact information change and effective date in a memory store;
automatically communicating the contact information change and effective date to a second electronic device; and
applying the received contact information change to a contact information list in a memory store of the second device, on or after the effective date.

2. The method of claim 1, wherein automatically communicating the contact information change and effective date to a second electronic communication device, further includes: upon a request for communication with the second device, automatically communicating the contact information change and effective date to a second electronic communication device.

3. The method of claim 1, wherein: automatically detecting a change in a user contact information at a first electronic communication device includes detecting new contact information or a change in existing contact information; and
determining effective date of the change in the contact information includes receiving the effective date of the change in the contact information from a user of the first device.

4. The method of claim 1, wherein applying the contact information change further includes:
at the second device, comparing the effective date with a current date, such that if the effective date is on or after the current date, then applying the contact information change to a contact information list in the second device.

5. The method of claim 1, wherein:
automatically communicating the contact information change and effective date further includes automatically communicating the contact information change and effective date to multiple other electronic communication devices; and
applying the contact information change includes applying the contact information change contact information list in a memory store of each of a plurality of said other devices, on or after the effective date.

6. The method of claim 1, wherein automatically communicating the contact information change and effective date further includes automatically selectively communicating the contact information change and effective date to electronic communication devices of users with contact information in a contact information list at the first electronic communication device.

7. The method of claim 1, wherein applying the contact information change further includes automatically applying the contact information change to the contact information list in the memory store of the second device, on or after the effective date.

8. A management client system for managing user contact information in electronic devices, comprising:
a detection module configured for detecting a change in a user contact information for a first electronic device, determining effective date of the change in the contact information and storing the contact information change and effective date in a memory store; and
a communication module configured for automatically communicating the contact information change and effective date to a second electronic device for applying the received contact information change to a contact information list in a memory store of the second device, on or after the effective date.

9. The system of claim 8, wherein the communication module is configured such that, upon a request for communication with the second device, the communication module automatically communicates the contact information change and effective date to a second electronic communication device.

10. The system of claim 8, wherein:
the detection module is further configured for detecting new contact information or a change in existing contact information, and receiving the effective date of the change in the contact information from a user of the first device.

11. The system of claim 8, wherein the communication module is configured for automatically communicating the contact information change and effective date to multiple other electronic communication devices.

12. The system of claim 8, wherein the communication module is configured for automatically selectively communicating the contact information change and effective date to electronic communication devices of users with contact information in a contact information list at the first electronic communication device.

13. The system of claim 8 further comprising:
a parsing module configured for detecting a contact information change notification in a received communication from the first device, the contact information change notification indicating a change in a user contact information at the first device, the parsing module further configured for determining an effective date of the change in the contact information; and
an updating module configured for applying the received contact information change to a contact information list in the second device, on or after the effective date.

14. The system of claim 13 wherein the updating module is configured for
comparing the effective date with a current date, such that if the effective date is on or after the current date, then applying the contact information change to the contact information list.

15. The system of claim 13 wherein the updating module is configured for automatically applying the contact information change to the contact information list on or after the effective date.

16. A management client for managing user contact information in an electronic device, comprising:
a parsing module configured for detecting a contact information change notification in a received communication, the contact information change notification indicating a change in a user contact information at another electronic device, the parsing module further configured for determining an effective date of the change in the contact information; and
an updating module configured for applying the received contact information change to a contact information list, on or after the effective date.

17. The management client of claim 16 wherein the updating module is configured for
comparing the effective date with a current date, such that if the effective date is on or after the current date, then applying the contact information change to the contact information list.

18. The management client of claim 16, wherein the updating module is configured for automatically applying the contact information change to the contact information list on or after the effective date.

19. The management client of claim 16, wherein the contact information change includes new contact information or a change in existing contact information

20. The management client of claim 16, wherein the electronic device comprises a consumer electronic device.
